(19) United States
(12) Patent Application Publication
(10) Pub. No.: US 2007/0005558 A1
(43) Pub. Date: Jan. 4, 2007

(54) Asset management system

(75) Inventor: Andrew O. Canfield, Portland, OR (US)

Correspondence Address: BROOKS KUSHMAN P.C., 1000 TOWN CENTER, TWENTY-SECOND FLOOR, SOUTHFIELD, MI, 48075, US

(73) Assignee: Comcast Cable Holdings, LLC, Philadelphia, PA (US)

(21) Appl. No.: 11/173,249

(22) Filed: Jul. 1, 2005

(51) Int. Cl. G06F 17/30

(52) U.S. Cl. 707/1

(57) ABSTRACT

A system for managing assets includes at least one asset located within a geographic area and a server configured to store data associated with the assets. The server may be adapted to store data associated with the asset location and be updated with current asset data by at least one administrator. The server is further adapted to generate and integrate asset symbols within an electronic spatial illustration of the geographic area wherein the location of the asset symbol on the spatial illustration corresponds to the location of the asset within the geographic area. The system further includes a portable device that communicates with the server and is adapted to display the data generated by and stored on the server. The portable device is also adapted to receive inputs from a user, display data in response to the user inputs, and display the spatial illustration having the integrated asset symbols and asset locations.

### TECHNICAL FIELD

The present invention relates to a system for managing assets through the use of a geographic information system.

### BACKGROUND

The analysis and management of data from a geographic perspective has become of great importance. Geographic information systems (GIS) have experienced increased usage by businesses and governments alike because of the ability to manipulate, analyze and present information that relates to geographic areas. The conventional GIS includes a desktop computer and/or a server based software system. The desktop computer or server stores maps, data and other related information that may be assessed by a user through the use of GIS software. The software is capable of analyzing the stored data and providing this data to the user.

Even more recently, handheld/portable devices such as a personal digital assistant (PDA) have been incorporated with GIS to access data stored on a server. Through the use of these portable devices, the user may import maps and other map-related data to access data located on the server. Although the foregoing GIS/PDA systems have experienced increased usage, these systems possess several disadvantages. For example, the conventional systems that utilize have proven to be costly and inefficient. Additionally, the conventional GIS/PDA systems are primarily a navigation/routing tool that is designed to display maps for driving directions. Accordingly, these systems have proven to be inadequate at enabling efficient and cost-effective management of assets.

The present invention was conceived in view of these and other disadvantages of conventional GIS and asset management systems.

### SUMMARY

The present invention provides a system for managing assets. Accordingly, an asset management system is provided that includes at least one asset located within a geographic area and a server configured to store data associated with the assets. The server may be adapted to store data associated with the asset location and be updated with current asset data by at least one administrator. The server is further adapted to generate and integrate asset symbols within an electronic spatial illustration of the geographic area wherein the location of the asset symbol on the spatial illustration corresponds to the location of the asset within the geographic area. The system further includes a portable device that communicates with the server and is adapted to display the data generated by and stored on the server. The portable device is also adapted to receive inputs from a user, display data in response to the user inputs, and display the spatial illustration having the integrated asset symbols and asset locations.

A method is disclosed for managing a system of assets wherein the system includes at least one asset located within a geographic area. The method comprises configuring a server to store data associated with the asset wherein the data includes an asset location. The method further includes updating the server with current asset data wherein the data is input by at least one administrator. The method also comprises generating asset symbols and an electronic spatial illustration of the geographic area, wherein the location of the asset symbol on the spatial illustration corresponds to the location of the asset within the geographic area.

The method also includes displaying data generated by and stored on the server through the use of a portable device, wherein the portable device is adapted to receive inputs from a user and transmit signals to the server that correspond to the user inputs. The portable device is further adapted to display data in response to the user inputs and display the spatial illustration having the integrated asset symbols and asset locations.

### BRIEF DESCRIPTION OF THE DRAWINGS

These and other features and advantages of the invention will be apparent from the following detailed description and the appended claims, taken in conjunction with the accompanying drawings, in which:

FIG. 1 is an illustration of an asset management system in accordance with an embodiment of the present invention;

FIG. 2 is a software diagram illustrating a data flow and data processing between the portable device and server shown in FIG. 1 in accordance with an embodiment of the present invention; and

FIGS. 3-18 illustrate the portable device of FIG. 1 having various screen displays in accordance with an embodiment of the present invention.

### DETAILED DESCRIPTION OF THE PREFERRED EMBODIMENT(S)

By way of example, a system and methodology for implementing the present invention is described below. The provided system and methodology may be adapted, modified or rearranged to best fit a particular implementation without departing from the scope of the present invention.

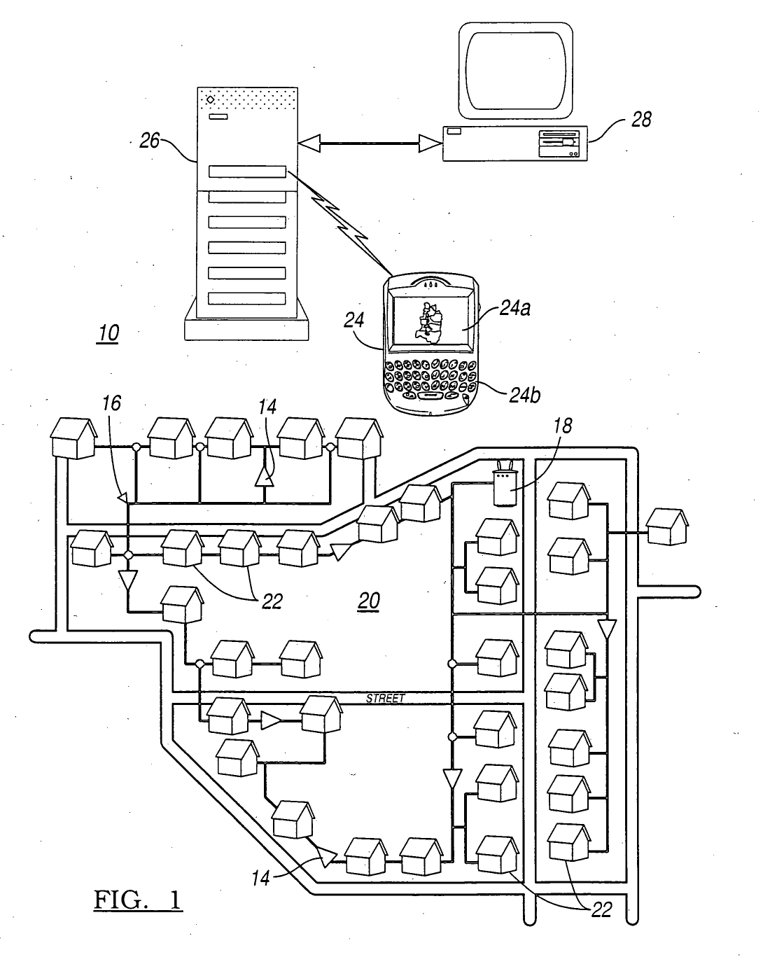

FIG. 1 illustrates an asset management system 10 that enables efficient and cost-effective management of assets located within a geographic area 20. In one aspect of the invention, the managed assets include an amplifier 14, a cable line 16, and a power supply 18 that are strategically located within geographic area 20. Asset management system 10 further includes a portable device 24, a server 26, and an administrator 28.

Portable device 24 may be utilized by a service technician while making service calls to customers 22 within geographic area 20. Portable device 24 may be a personal digital assistant (PDA), a cellular telephone, or a handheld computer. Accordingly, portable device 24 includes a display 24a and a keypad 24b. Accordingly, portable device 24 is configured to process, store, and retrieve data. Portable device 24 is also adapted to communicate with server 26. Server 26 is configured to store data associated with assets 14, 16 and 18, and receive updated asset data from administrator 28 and portable device 24. In one aspect, administrator 28 receives information pertaining to assets 14, 16 and 18. In response, administrator 28 transmits the received information to server 26. As such, administrator 28 may be a desktop computer or any device capable of receiving asset data and transferring the asset data to server 26. Portable device 24 is capable of accessing the received data located on server 26. The asset data located on server 26 may include spatial illustrations of geographic area 20 (e.g., a map), the location of assets 14, 16 and 18 within geographic area 20, and data related to the specific asset type and configuration. Server 26 is also capable of analyzing the information/data received from administrator 28. In particular, server 26 is capable of generating asset symbols that correspond to assets 14, 16 and 18 and integrating the asset symbols with the spatial illustration. Additionally, the asset symbols generated by server 26 may be configured to indicate the condition or state of the asset. For example, server 26 may be configured to generate a display showing the asset symbols wherein the color or shade of the asset symbol indicates whether the asset is in proper operating condition. Server 26, in one aspect, is further configured to determine the distances between a user of portable device 24 and the location of assets 14, 16 and 18. As described above, the information stored and/or generated by server 26 is accessible by portable device 24.

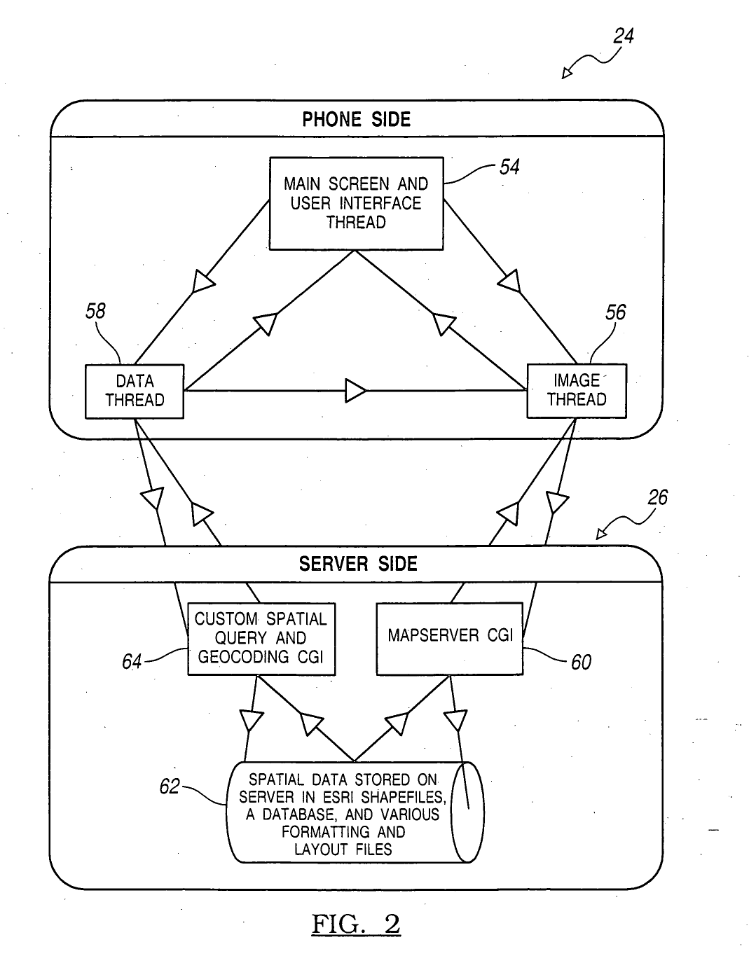

Referring to FIG. 2, a software diagram is shown that illustrates the flow and processing of data between portable device 24 and server 26. Upon startup of portable device 24, a main screen/user interface thread 54 spawns a data request thread 58 to a file located on server 26 having a predetermined format. In one embodiment, the file contains map information for geographic area 20 (FIG. 1) such as geographic and/or system layer names, and map extents. Also, the main thread is configured to parse the return from data thread 58 and spawn an image request thread 56 to a mapserver common gateway interface (CGI) 60 with the parameters needed for the mapserver to generate an image from spatial data stored on server 26 (block 62). In one aspect of the invention, the spatial data stored on server 26 may utilize spatial file formats developed by the Environmental Systems Research Institute, Inc. (ESRI), 380 New York Street, Relands, Calif. 92373-8100. Mapserver CGI 60 responds to the request with an image file in a graphical format. In one embodiment, the graphical format is the portable network graphics (PNG).

As such, image thread 56 streams the image into a buffer and creates an image object. This image may the be sent back to the main screen thread 54, wherein main screen thread 54 is configured to display the image on display 24a (FIG. 1). When a user selects a move, pan or zoom function, the current coordinates are adjusted and the main thread 54 updates the request string in the image thread 56. The image thread then sends the request to the mapserver CGI 60 which responds with a new image of the required data having an adjusted coordinate area in accordance with the selected move, pan or zoom function.

Data requests that occur when a user initiates a query or a geocode (to be described below) may be sent in a similar fashion. In one embodiment, an alternative CGI may be utilized that does not require the use of the Mapserver. The CGI in such an embodiment responds with the query, search or geocode results in a graphical format such as extensible mark-up language (XML). The data thread 58 may send that XML graphic to the main thread 54 which is then parsed to retrieve the results. The results are then displayed to the user for viewing.

Additionally, in the case of a search or a geocode, data thread 58 may send the data to the main thread 54, which then takes that information and provides it to the image thread 56. Image thread 56 receives the data and sends a request to the Mapserver CGI 60 which returns an image which is ultimately displayed on display 24a (FIG. 1) for viewing by the user. The foregoing cycle may be repeated in various orders depending on the user's input.

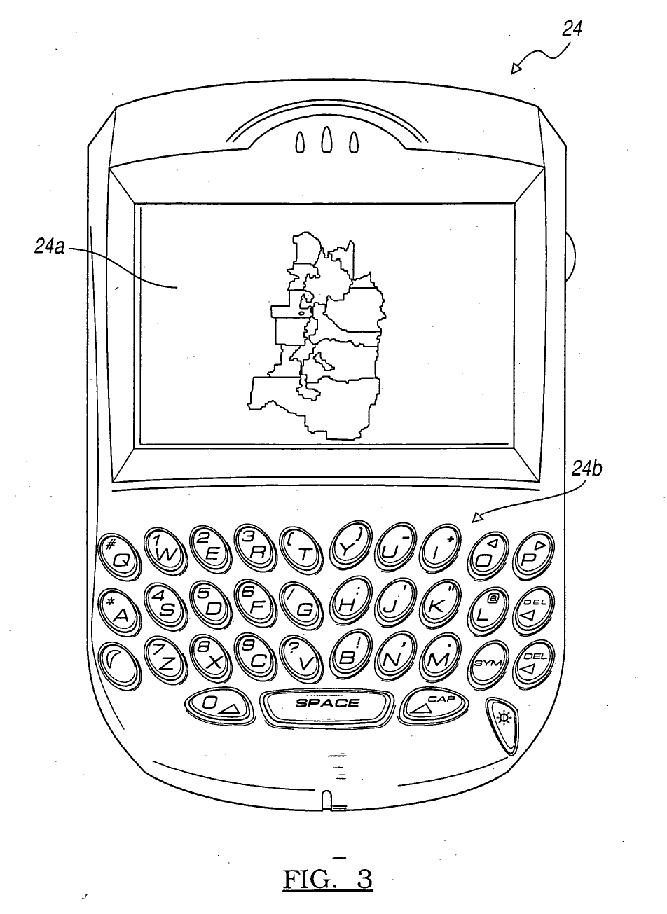

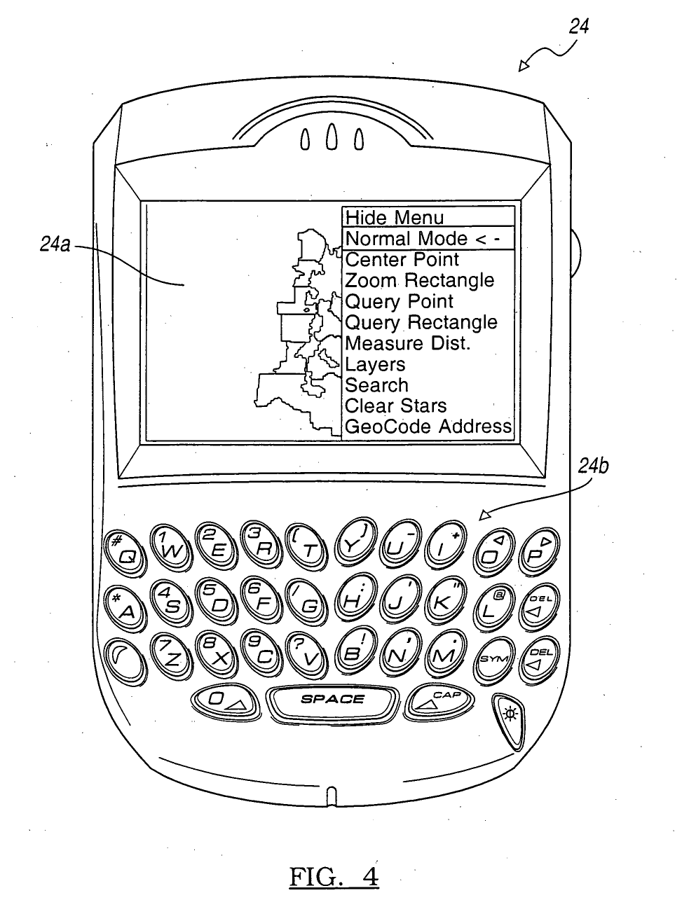

Now, referring to FIG. 3 and as described in the foregoing, an electronic spatial illustration of geographic area 20 may be displayed on display 24a. Keypad 24b enables the user (i.e., a service technician) to input data requests, which are received by server 26. As such, as shown in FIG. 4, portable device 24 displays a menu that enables the user to request specific information for display and select various graphic display options. As information/data is input by administrator 28, the updated information may be accessible virtually immediately through the use of portable device 24, thereby providing the user the most recent asset information. This continuously updated display of asset data enables cost-effective management of the assets. For instance, if administrator 28 updates the operating status of amplifier 14 from a non-working status to a fully functional status, then the user (i.e., the service technician) does not unnecessarily expend time and/or resources attempting to find and troubleshoot amplifier 14. The graphic illustrations and asset data displayed on portable device 24 further enables the user to quickly identify the specific location of an asset that is not working properly. As such, the service technician can provide prompt service to customers 22 (FIG. 1) without expending time making trips to a customer service center (not shown) or reviewing maps of the geographic area where the troubled asset is thought to be located.

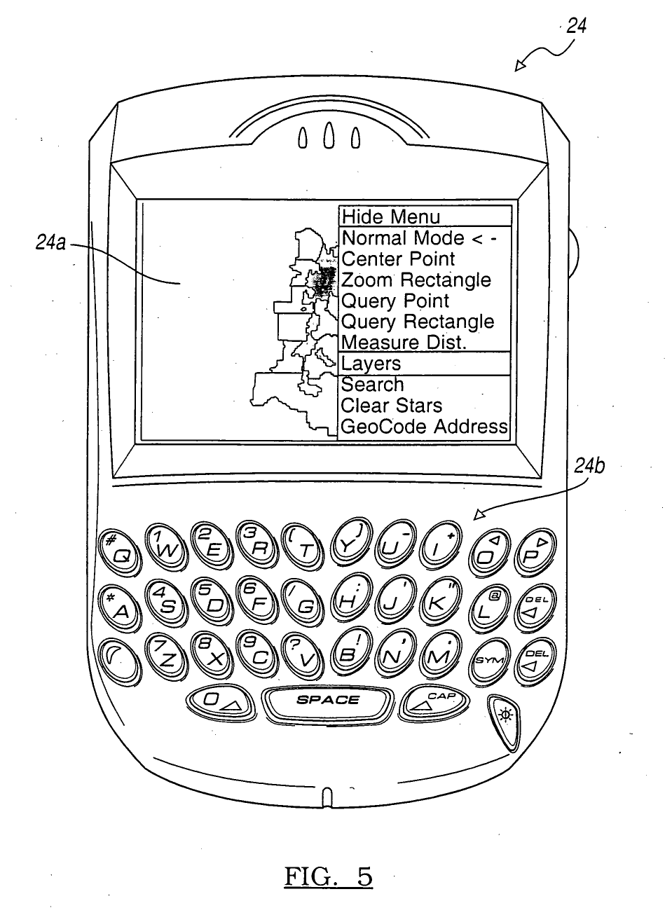

To expedite servicing and/or maintenance of assets 14, 16 and 18, server 26 is configured to store various data layers that are associated with the respective assets. These data layers are geographically positioned system layers that are capable of being mapped through the use of server 26 and portable device 24. For example, the data layers may correspond to an aerial or underground illustration of the system of assets. Accordingly, referring to FIG. 5, portable device 24 displays the user menu that includes a “Layers” option for displaying various system layers.

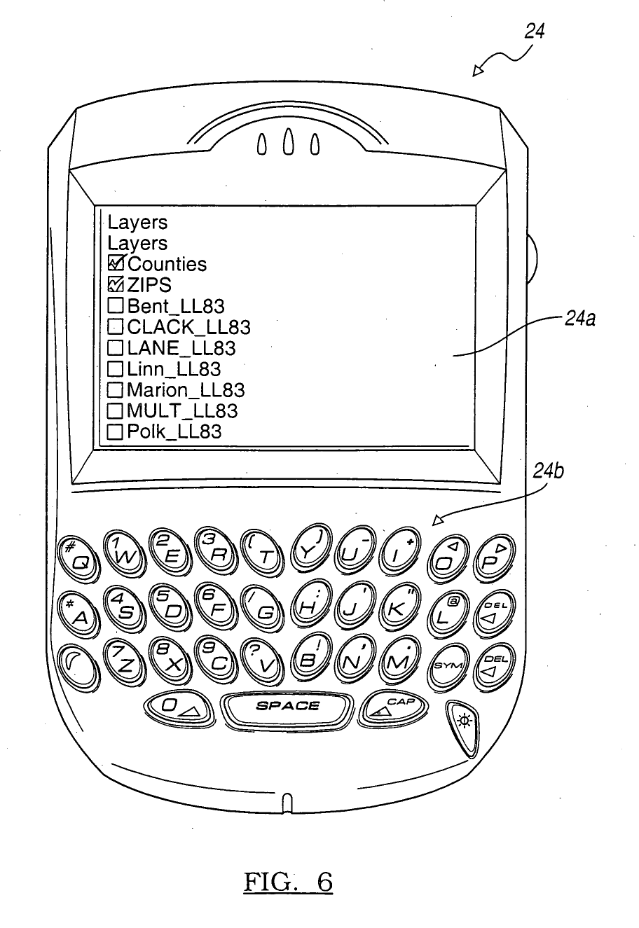

Now, referring to FIG. 6, a list of layers is illustrated on display 24a. In the embodiment shown, the layers include selections for respective counties within geographic area 20 (FIG. 1). In one aspect of the invention, each data layer has a layer identification associated with the layers. For example, as shown in FIG. 6, the layer identifications associated with the respective geographic layers include “counties” and “zips”. Additionally, each layer may include fields in which values may be entered and searched via portable device 24.

As shown in FIG. 6, the geographic layer having the layer identification counties and zips (e.g., zip code) has been selected. Upon selection of a particular layer(s), the server 26 will generate a spatial illustration (e.g., a map), thereby illustrating the particular layer(s) selected. In the embodiment shown in FIG. 6, the selectable layer(s) include a listing of counties within a particular state.

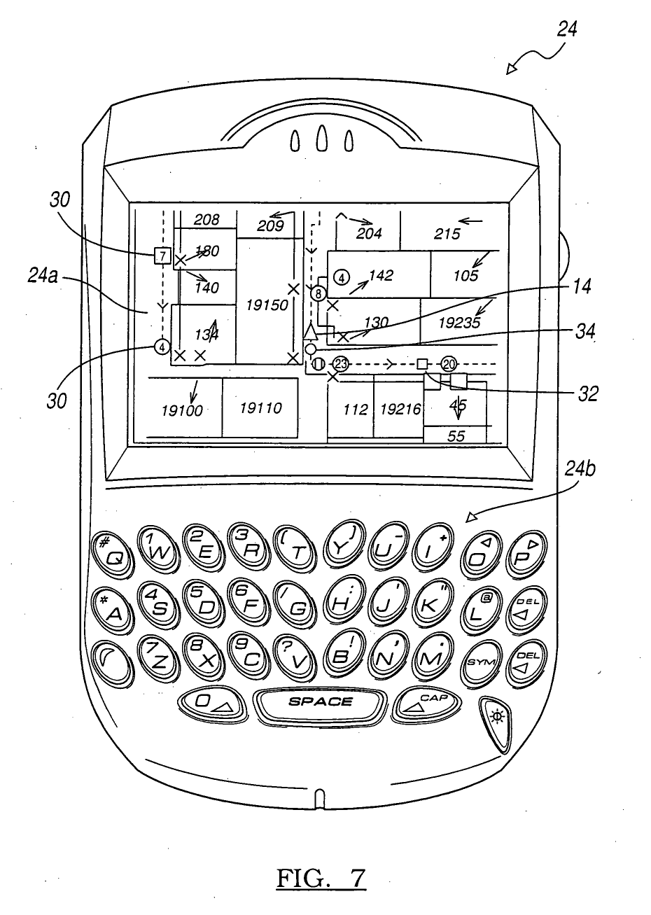

Referring to FIGS. 7-9, various embodiments of a selectable design layer are illustrated. Specifically, as shown in FIG. 7, a spatial illustration of a geographic area is shown that includes assets that are embedded within the spatial illustration in a way that corresponds to the actual location of the asset within the geographic area. The functionality of server 26 and portable device 24 enables a service technician to quickly identify assets that require servicing and/or maintenance without repeated trips to the customer service center or time consuming review of hard-copy area and system maps.

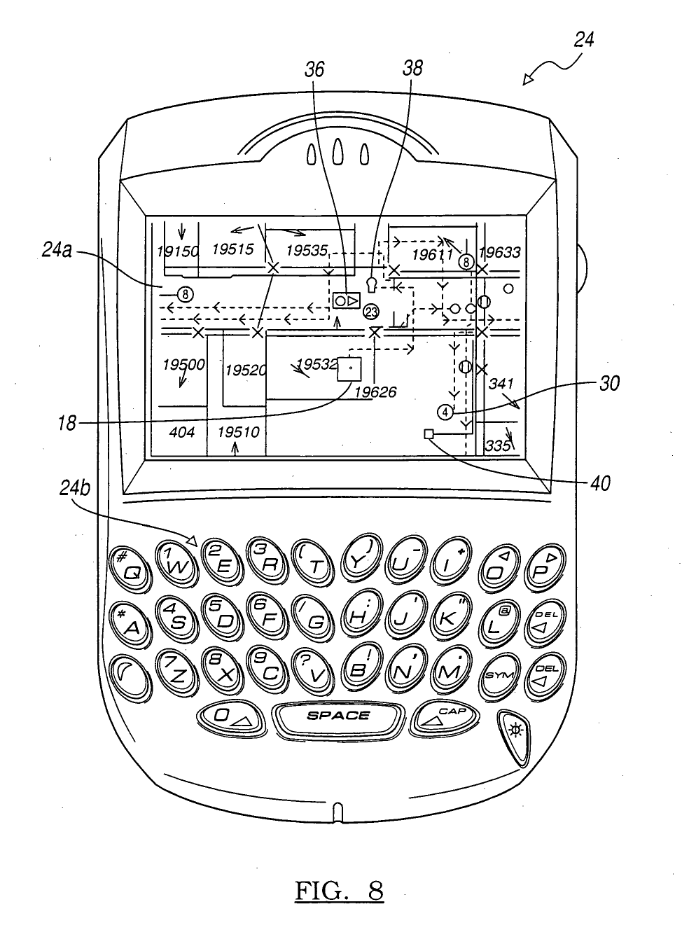

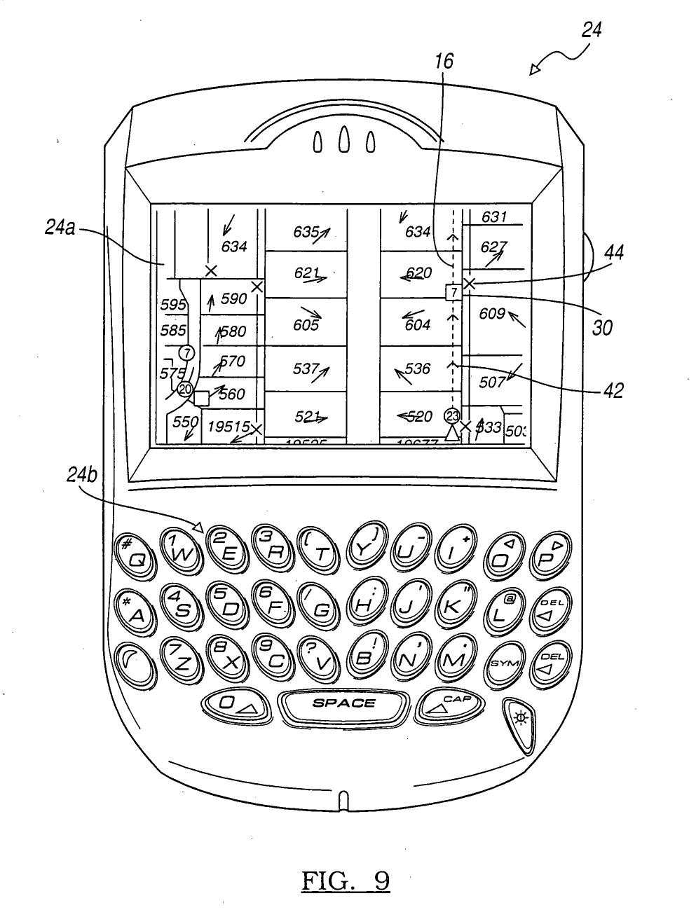

In the embodiments shown in FIGS. 7-9, the assets that are illustrated include amplifier 14, a tap 30, a splice 32 and a splitter 34. As recognized by one of ordinary skill in the art, the above assets are commonly used in a cable service system. It is recognized however, that the managed assets may be any system component and/or device without departing from the scope of the present invention including but not limited to any physical asset of a utility or telecom network. Accordingly, as shown in FIGS. 8 and 9, through the use of server 26 and portable device 24, the managed assets may include power supply 18, a node receiver 36, a power inserter 38, a lock box 40, a cable 16, a pole 44, and a digital or analog radio frequency signal that is indicated by an asset symbol 42. Each of the managed assets includes at least one asset symbol wherein the shade and/or color of the asset symbol on display 24a may indicate the condition or state of the asset.

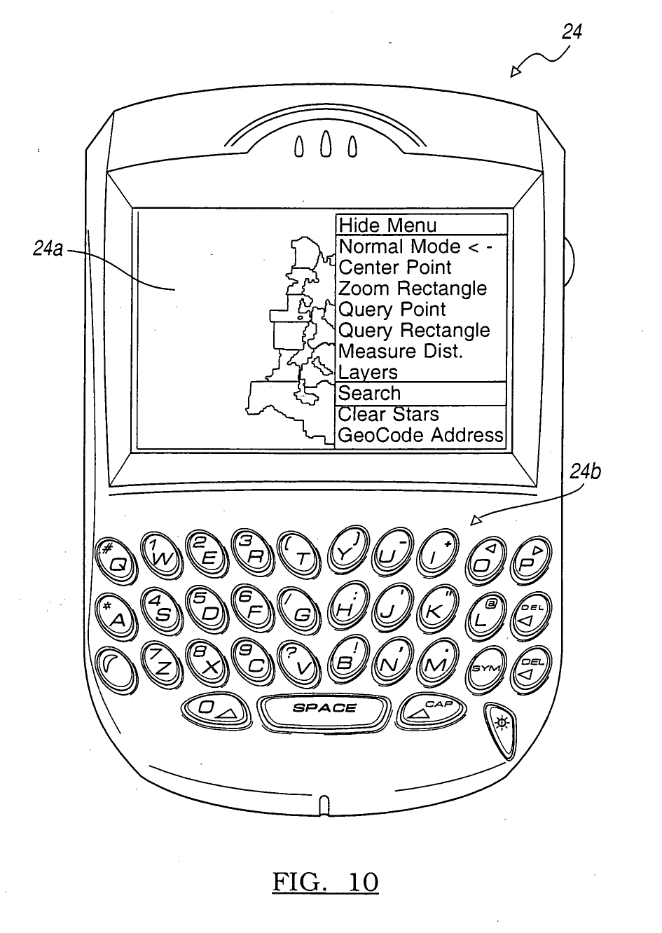

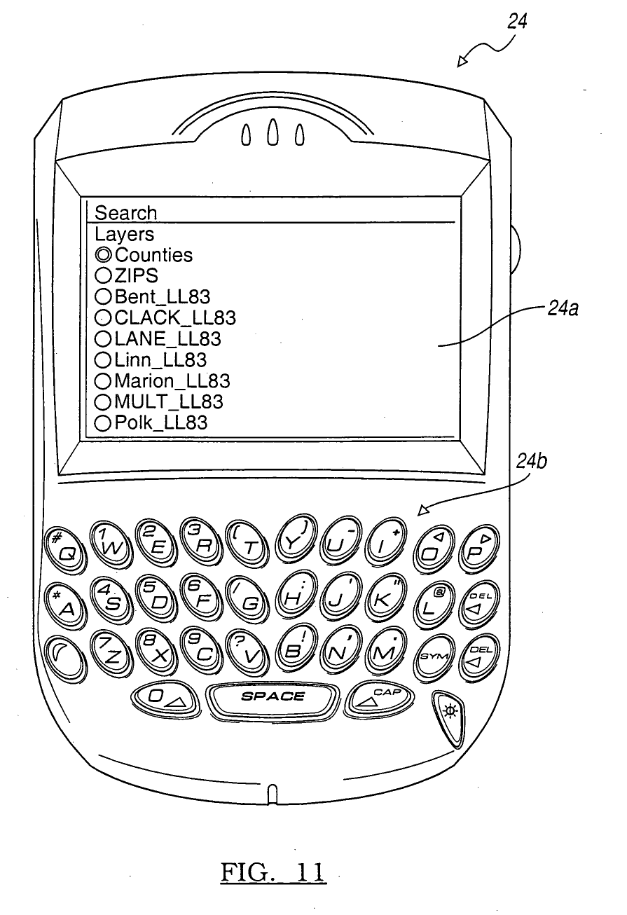

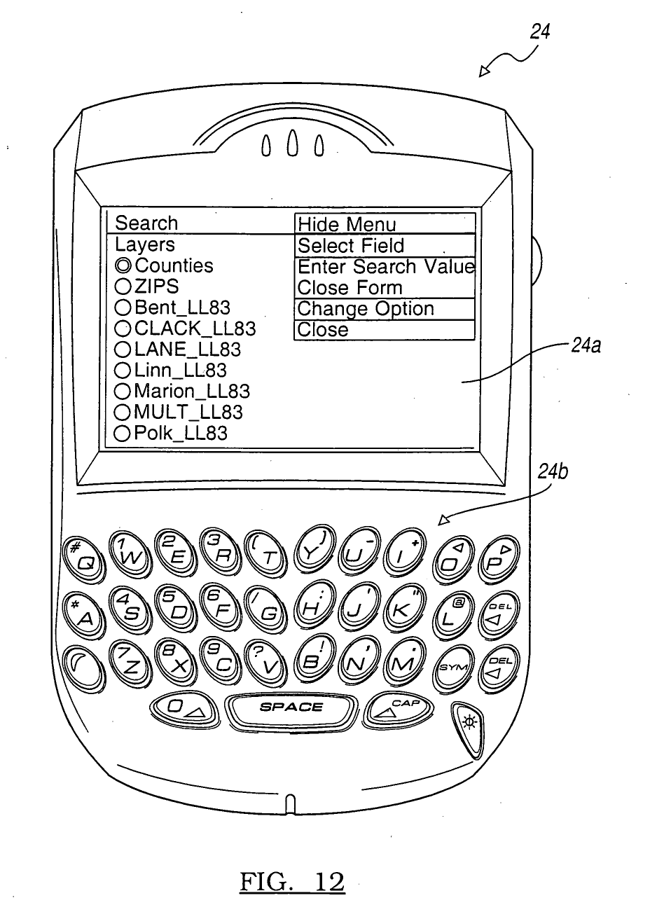

As described in the foregoing, server 26 is searchable through the use of portable device 24. Accordingly, portable device 24 includes a search option within the menu illustrated by FIG. 10. The user may simply select the search option from the menu to initiate a search for data/information located on server 26. The search option further enables any field of any layer to be searched by inputting a search criteria or selecting a particular value for searching. In one embodiment, the search criteria includes longitude and latitude coordinates that enable a specific location to be displayed on portable device 24. As shown in FIGS. 11 and 12, the user may select a layer and specific field within the selected layer to search for a particular location and/or asset. Once the criteria has been entered and the user executes the search query, the server 26 will generate the requested information that may include a graphic illustration of the geographic area having the managed asset.

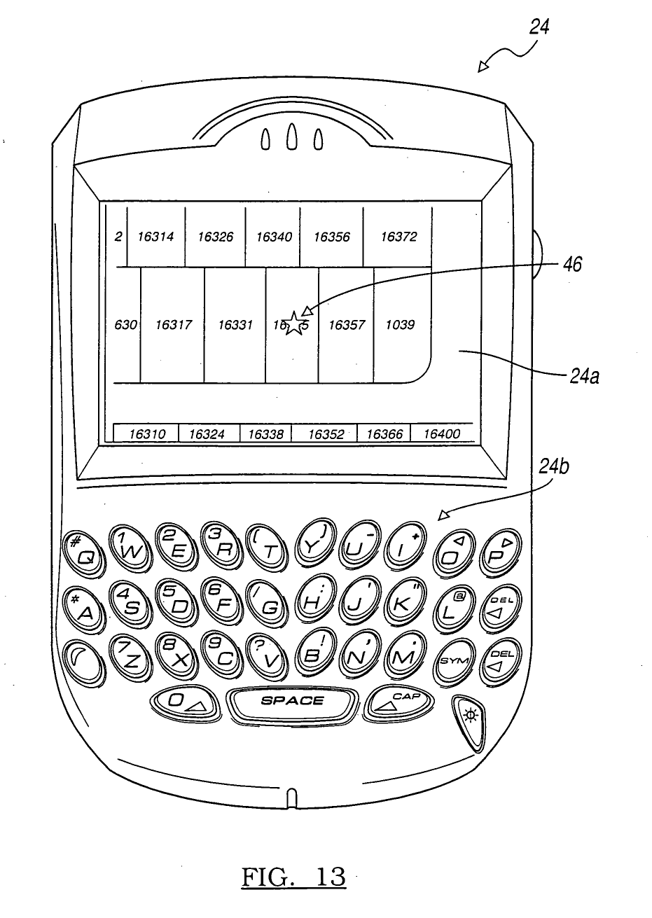

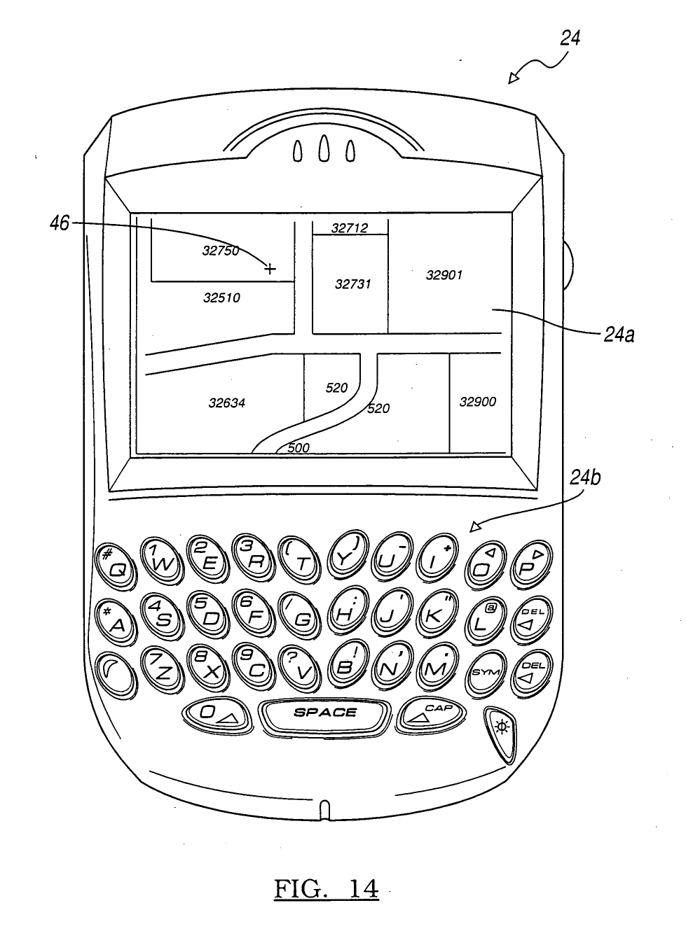

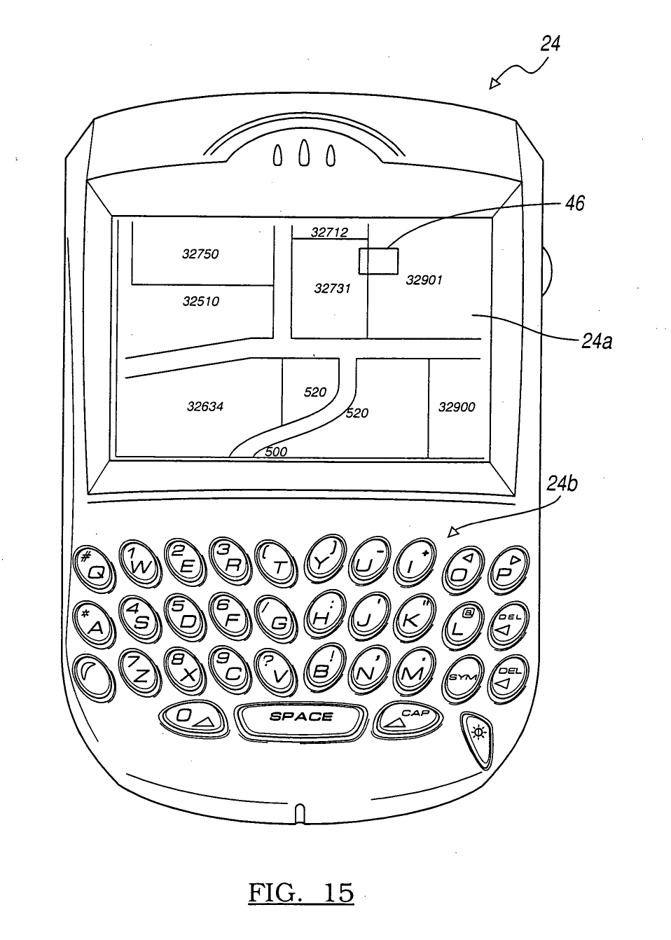

Referring to FIG. 13, portable device 24 displays a geographic area that includes one asset as indicated by a location symbol 46. It is recognized that the symbol used to denote the location of a managed asset may be any symbol, such as a star, a point or a rectangle as illustrated in FIGS. 13 through 15. In one embodiment, the user may select various display modes thereby customizing the display of a geographic area having assets located throughout.

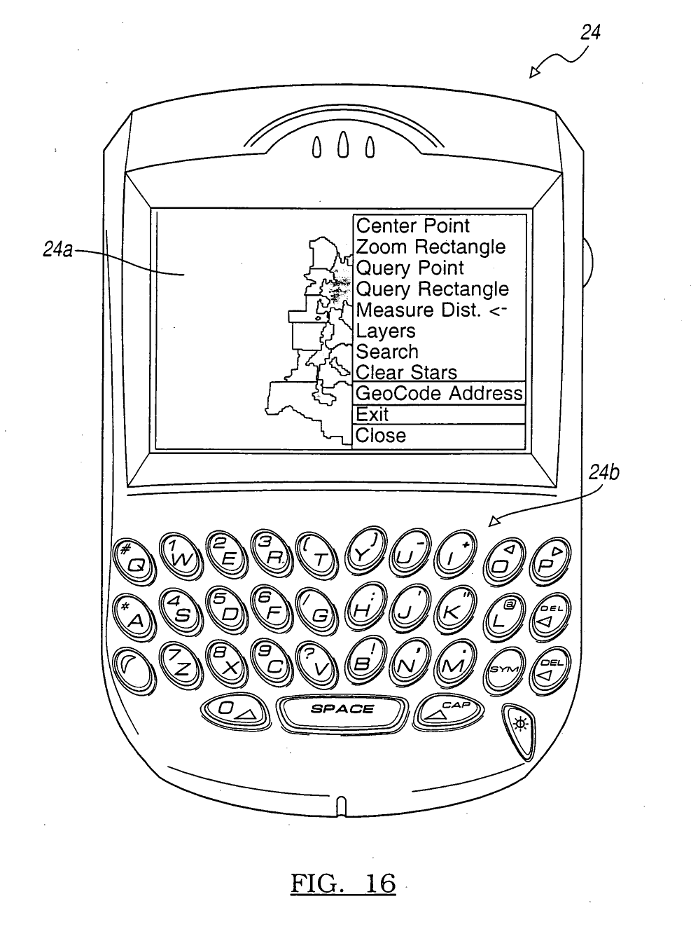

Server 26 is further adapted to store location data that is associated with a geographic area. Through the use of portable device 24 and server 26, the user may geocode an address. Geocoding enables a point or area on the Earth's surface to be determined based on specific criteria such as the location data. Accordingly, in the embodiment shown in FIG. 16, the user may select to geocode an address from the menu displayed by portable device 24. In another aspect, administrator 28 may geocode an address.

In the embodiment shown, the specific operation includes a street level geocode that enables searching of a street database for street addresses that are input by the user. Once server 26 identifies a street that corresponds to the search criteria, the server 26 filters the results by an address range that is compared to the original search criteria. If the address/street name falls within a valid range, the server 26 calculates where the address should be located if it exists and portable device 24 displays a map or grid that includes a location symbol where the address is located.

In one aspect, the user can also filter the search results by zip code thereby reducing the chance of finding results in two cities that have a similar street name and/or address ranges through the geocode operation. Nevertheless, where multiple search criteria results are found, these results are illustrated on the spatial illustration as either a star, a rectangle or a point (i.e., the location symbol).

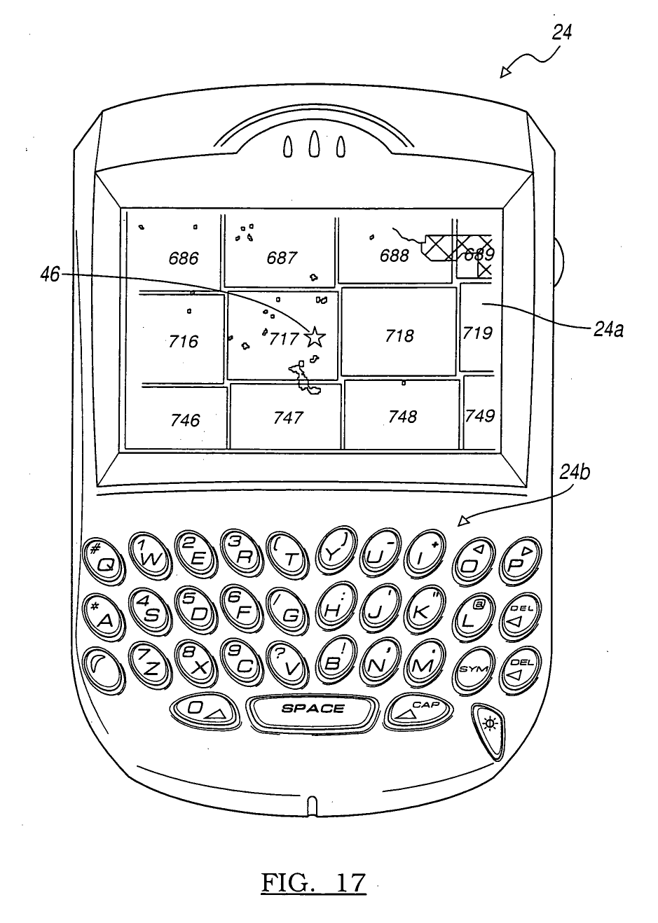

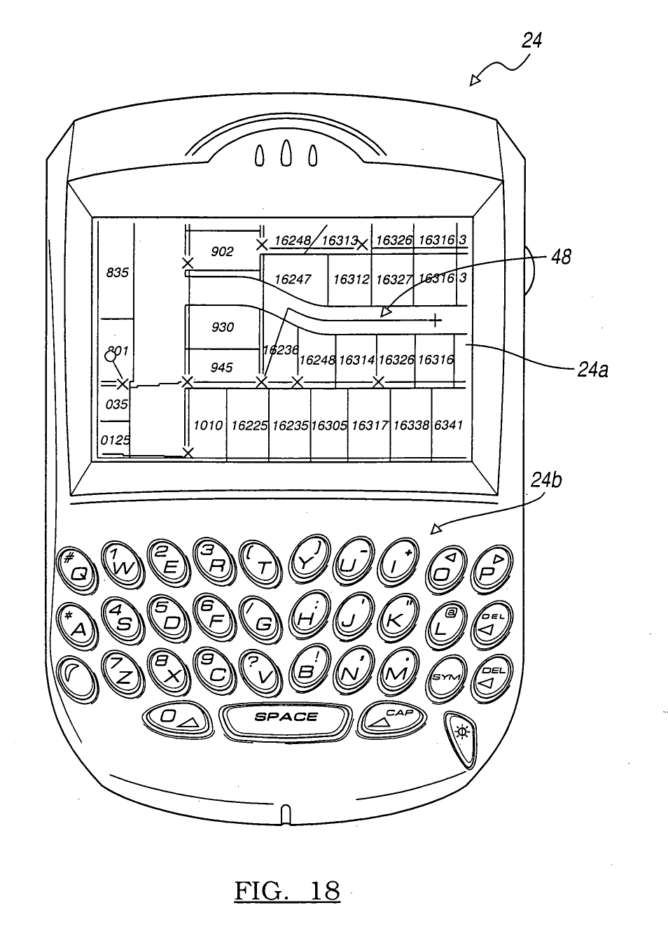

Accordingly, referring to FIG. 17 following execution of an address geocode, an image of the particular geographic area is illustrated having a star that denotes the location of the managed asset within the geographic area. In this embodiment, the illustration includes a spatial grid wherein the spatial grid may correspond with a physical copy of the geographic area, such as a spatial grid commonly found within a “Thomas Guide,” which is available from Rand McNally, 8255 N. Central Park, Skokie, Ill. 60076. Accordingly, the user may utilize the physical copy of his/her “Thomas Guide” and find the exact point illustrated by the electronic spatial grid and drive to the location denoted by the star.

As described above, portable device 24, having data storage and data processing capability, is configured to determine (i.e., calculate) distances between portable device 24 and a managed asset. Such functionality enables precise scheduling for travel and service calls. Accordingly, the user may input the current location through the use of keypad 24b. The user can then select any assets displayed by portable device 24. As such, portable device 24 will calculate the distance between the user's current location and the managed asset, and generate a display of the calculated distance for the user.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An asset management system comprising:
at least one asset located within a geographic area;
a server configured to store data associated with the asset wherein the data includes an asset location, the server being updated with current asset data by at least one administrator and adapted to generate and integrate asset symbols with an electronic spatial illustration of the geographic area, wherein the location of the asset symbol on the spatial illustration corresponds to the location of the asset within the geographic area; and
a portable device communicative with the server and adapted to display the data generated by and stored on the server, the portable device adapted to receive inputs from a user, display data in response to the user inputs, and display the spatial illustration having the integrated asset symbols and asset locations.

2. A system according to claim 1, wherein the portable device is further configured to determine distances between the user and the asset location.

3. A system according to claim 1, wherein the server is further configured to be searchable for asset data through the use of the portable device.

4. A system according to claim 3, wherein the server is searched in response to the user inputting a search criteria into the portable device.

5. A system according to claim 4, wherein the search criteria includes longitude and latitude coordinates.

6. A system according to claim 1, wherein the asset symbols are configured to indicate the condition or state of the asset.

7. A system according to claim 1, wherein the server contains a plurality of data layers associated with the asset.

8. A system according to claim 7, wherein the plurality of data layers have a layer identification associated with the layers.

9. A system according to claim 8, wherein the layers include fields that contain searchable data.

10. A system according to claim 1, wherein the stored data associated with the asset includes asset type and configuration information.

11. A system according to claim 1, wherein the asset location is denoted by a location symbol that is a star, a point, or a rectangle.

12. A system according to claim 1, wherein the server is adapted to geocode locations based on values received from the portable device or the administrator.

13. A system according to claim 1, wherein the server is adapted to generate and integrate an electronic spatial grid with the asset symbol, wherein the spatial grid corresponds to a physical illustration of the spatial grid.

14. A system according to claim 1, wherein the at least one asset includes a tap, an amplifier, a splice, a splitter, a node receiver, a power inserter, a power supply, or a lock box.

15. A system according to claim 1, wherein the asset symbols correspond to the direction of an electronic signal, a cable, or a pole.

16. A system according to claim 1, wherein the portable device is a computer, a personal digital assistant (PDA) or a cellular telephone.

17. A system according to claim 1, wherein the portable device includes a main thread that is configured to:
spawn a data request thread that is received by the server in response to the user inputs;
parse the return from the data request thread;
spawn an image request thread to a mapserver common gateway interface (CGI) located on the server wherein the server generates an image file in a graphical format which is received by the main thread; and
display the data received by the main thread in response to the user inputs for viewing by the user.

18. A method of managing a system of assets wherein the system includes at least one asset located within a geographic area, the method comprising:
configuring a server to store data associated with the asset wherein the data includes an asset location;
updating the server with current asset data wherein the data is input by at least one administrator;
generating asset symbols and an electronic spatial illustration of the geographic area through the use of the server, wherein the location of the asset symbol on the spatial illustration corresponds to the location of the asset within the geographic area; and
displaying data generated by and stored on the server through the use of a portable device, the portable device being adapted to:
receive inputs from a user and transmit signals to the server that correspond to the user inputs,
display data in response to the user inputs, and
display the spatial illustration having the integrated asset symbols and asset locations.

19. A method according to claim 18, further comprising configuring the portable device to determine distances between the portable device and the asset location and generate an output corresponding to the distance that is displayed on the portable device.

20. A method according to claim 18, further comprising:
configuring the server to be searchable for asset data through the use of the portable device; and
searching the server in response to the user inputting a search criteria into the portable device.

21. A method according to claim 20, wherein inputting a search criteria includes inputting longitude and latitude coordinates.

22. A method according to claim 18, wherein generating the asset symbols and the electronic spatial illustration of the geographic area includes asset symbols that are configured to indicate the condition or state of the asset.

23. A method according to claim 18, further comprising:
configuring the server to store a plurality of data layers associated with the asset, wherein the plurality of data layers have a layer identification.

24. A method according to claim 23, wherein configuring the server to store a plurality of data layers further includes data layers that contain searchable values.

25. A method according to claim 18, wherein configuring the server to store data associated with the asset includes data associated with the asset type or configuration.

26. A method according to claim 18, wherein displaying data generated by and stored on the server through the use of a portable device that includes a main thread, the method comprising:
spawning a data request thread that is received by the server in response to the user inputs;
parsing the return from the data request thread;
spawning an image request thread to a mapserver common gateway interface (CGI) located on the server wherein the server generates an image file in a graphical format which is received by the main thread; and
displaying the data received by the main thread in response to the user inputs for viewing by the user.
